(19) United States
(12) Patent Application Publication
(10) Pub. No.: US 2015/0229236 A1
(43) Pub. Date: Aug. 13, 2015

(54) ZERO-BIAS CAPACITIVE MICROMACHINED ULTRASONIC TRANSDUCERS AND FABRICATION METHOD THEREOF

(71) Applicant: National Taiwan University, Taipei City (TW)

(72) Inventors: Wei-Cheng Tian, Taipei City (TW); Yu-Shan Tien, Taipei City (TW); Fang-Yu Lin, Taipei City (TW); Pai-Chi Li, Taipei City (TW)

(21) Appl. No.: 14/336,235

(22) Filed: Jul. 21, 2014

Related U.S. Application Data
(60) Provisional application No. 61/937,058, filed on Feb. 7, 2014.

(51) Int. Cl. H02N 1/08

(52) U.S. Cl. CPC H02N 1/08

(57) ABSTRACT

The present invention provides a zero-bias capacitive micromachined ultrasonic transducer element, comprising: a substrate having a lower electrode formed therein; a membrane structure that structurally supports an upper electrode over the lower electrode, wherein the upper electrode has at least one protruding part thereunder; a cavity between the substrate and the membrane structure; and a polymeric material coated on an inner surface of the cavity. The fabrication method of the zero-bias capacitive micromachined ultrasonic transducer element is also provided.

### CROSS REFERENCE TO RELATED APPLICATIONS

This application claims the benefit of U.S. provisional patent application 61/937,058, filed on Feb. 7, 2014, entitled “Non-invasive biomedical devices”, and hereby incorporated by reference in its entirety.

### BACKGROUND OF THE INVENTION

1. Field of the Invention

The present invention relates to capacitive micromachined ultrasonic transducers (CMUTs) and fabrication method thereof. More specifically, the present invention relates to zero-bias CMUTs and fabrication method thereof.

2. the Prior Arts

Transducers are devices that transform input signals of one form into output signal of a different form. Commonly used transducers include, heat sensors, pressure sensors, light sensors, and acoustic sensors. An example of an acoustic sensor is an ultrasonic transducer, which may be implemented in medical imaging, non-destructive evaluation, and other applications.

Historically, ultrasonic transducers have employed piezoelectric transducers elements to receive and transmit acoustic signals at ultrasonic frequencies. The performance of piezoelectric transducers is limited by their narrow bandwidth and acoustic impedance mismatch to air, water, and tissue. In an attempt to overcome these limitations, current research and development has focused on the production of capacitive micromachined ultrasonic transducer (CMUT) elements. CMUT elements are constructed on silicon using micromachining technique. A cavity is formed in a silicon substrate, and a thin layer suspended on the top of the cavity serves as a membrane on which a metallized layer acts an electrode, together with the silicon substrate which serves as a bottom electrode. Further, an AC signal applied between the electrodes with a DC bias causes the membrane to vibrate and emit sound. In this way it works as a transmitter. On the other hand, the biased CMUT element received sound waves cause the membrane to vibrate and provide a change in capacitance. In this way, it works as a receiver of ultrasonic waves.

Traditionally, CMUT has to be biased at approximately 80%-95% of the collapse voltage in order to increase the sensitivity. The requirement of an external DC bias not only increases the complexity of the front-end electronics, but also draws the reliability safety concerns. Accordingly, it would be an advance in the art to reduce or eliminate the need for an applied DC bias in CMUT operation.

In addition, when integrating the circuits and CMUTs monolithically, the SNR will be increased by removing the parasitic capacitances created by the wire-bonding between chips. The commercial CMOS process ensures the CMUT yield and thus reduces the fabrication cost. However, it is known that the CMOS-based design suffered from restrict process design rules, such as the thickness of each layers and fixed material for the device.

Therefore, there is a need in the art of ultrasonic transducers for a zero-bias capacitive micromachined ultrasonic transducer, further, the fabrication method of the zero-bias capacitive micromachined ultrasonic transducer could be compatible with CMOS process.

### SUMMARY OF THE INVENTION

In accordance with one aspect of the present invention, a zero-bias capacitive micromachined ultrasonic transducer element, comprising: a substrate having a lower electrode formed therein; a membrane structure that structurally supports an upper electrode over the lower electrode, wherein the upper electrode has at least one protruding part thereunder; a cavity between the substrate and the membrane structure; and a polymeric material coated on an inner surface of the cavity; wherein the zero-bias capacitive micromachined ultrasonic transducer element can operate without an DC voltage.

Preferably, the cavity has a height of 0.1˜0.2 μm.

Preferably, the polymeric material is a hydrophobic polymeric material and selected from the group consisting of Parylene, PDMS, PMMA, and Teflon. More preferably, the polymeric material is Parylene-C.

Preferably, a lower surface of the electrode has 1.2-fold to 5-fold surface area than an upper surface of the electrode.

In accordance with another aspect of the present invention, a method for fabricating a zero-bias capacitive micromachined ultrasonic transducer element, the method comprising the steps of: providing a substrate having a lower electrode formed therein; forming a sacrificial layer, a contact layer, an upper electrode and an insulation layer in sequence; removing the sacrificial layer thereby defining a cavity between the contact layer and the substrate; coating a sealant layer with a polymeric material thereby sealing the cavity, wherein the polymeric material flow into the cavity and coated on an inner surface of the cavity while coating the sealant layer.

Optionally, the lower electrode is disposed on the substrate or diffused in the substrate.

Preferably, the sacrificial layer has a height of 0.1˜0.2 μm and made of metal, silicon oxide, or polysilicon.

Preferably, the via layer has a crisscross shape.

The present invention also provides a capacitive micromachined ultrasonic transducer, which comprises the zero-bias capacitive micromachined ultrasonic transducer element as describe above.

### BRIEF DESCRIPTION OF THE DRAWINGS

FIG. 1 is a side view of a cross-section of an exemplary embodiment of a zero-bias capacitive micromachined ultrasonic transducer (CMUT) element.

FIG. 2A-G is a side view of a cross-section of an exemplary fabrication method embodiment of a zero-bias capacitive micromachined ultrasonic transducer (CMUT) element.

FIG. 3A-D is an exemplary embodiment of a CMOS-based zero-bias capacitive micromachined ultrasonic transducer (CMUT) element fabrication method. (A) after CMOS completion; (B) metal and via removal by strong acid etchant, the silicon oxide will be wash out by etchant; (C) remove all redundant layer and remove etching ditch and sacrificial layer; (D) seal the etching holes with Parylene-C in vacuum.

FIG. 4 is top view of CMUT observed by confocal microscopy.

FIG. 5 is transmit pressure measurement in (A) time domain and (B) frequency domain of CMUT element.

FIG. 6 is zero-bias CMUT element characterizations with 16 times averaging in (A) time domain and (B) frequency domain.

FIG. 7 is a schematic of experimental setup used for receive measurements of CMUT element.

FIG. 8 is receive signal measurement of conventional operated CMUT element.

FIG. 9 is using the CMUT element of present invention for nondestructive scanning of coin image.

### DETAILED DESCRIPTION OF THE PREFERRED EMBODIMENTS

The following description of the preferred embodiment of the invention is not intended to limit the invention to this preferred embodiment, but rather to enable any person skilled in the art of ultrasonic transducer devices to make and use this invention.

### Zero-Bias Capacitive Micromachined Ultrasonic Transducer Element

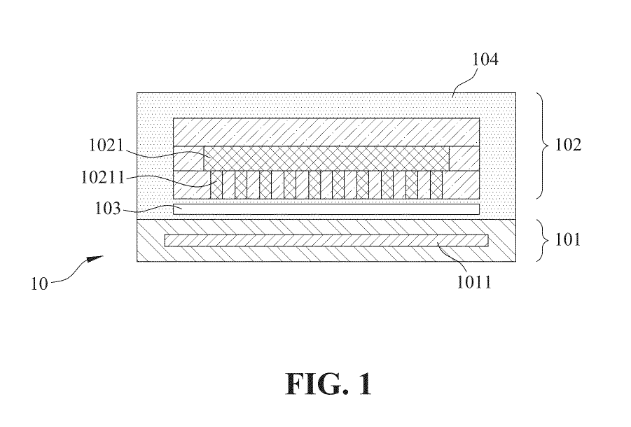

As shown in FIG. 1, a side view of a cross-section of an exemplary embodiment of a zero-bias capacitive micromachined ultrasonic transducer (CMUT) element 10 is illustrated. As will be appreciated by one skilled in the art, the figures are for illustrative purposes and are not drawn to scale. The present invention provides a zero-bias capacitive micromachined ultrasonic transducer element 10, comprising: a substrate 101 having a lower electrode 1011 formed therein; a membrane structure 102 that structurally supports an upper electrode 1021 over the lower electrode 1011, wherein the upper electrode 1021 has at least one protruding part 10211 thereunder; a cavity 103 between the substrate 101 and the membrane structure 102; and a polymeric material 104 coated on a inner surface of the cavity 103; wherein the zero-bias capacitive micromachined ultrasonic transducer element can operate without an DC voltage. The cMUT elements 10 function to generate an ultrasonic beam, detect an ultrasonic echo, and output electrical signals.

For a high sensitivity CMUT which is capable of operating in zero voltage as the present invention provided, it is important to minimize the height of the cavity 103 to less than 0.2 μm. However, in order to keep the membrane structure 102 free to vibrate, the height of the cavity 103 should be less than 0.1 μm.

The substrate 101 may include one of a glass, silicon or combination thereof. Further, the substrate 101 may include a p-type or an n-type silicon wafer. The lower electrode 1011 may be implanted in the substrate 101. Further, the lower electrode 1011 may include a p-type or an n-type material. Alternatively, the lower electrode 1011 may be diffused in the substrate.

The membrane structure 102 that functions to structurally support the upper electrode 1021 and allow for diaphragm-like motion. The membrane structure 102 including the supported upper electrode 1021 preferably act similar to a diaphragm, experiencing substantial deflection in response to electrostatic forces applied on the device and/or in response to an ultrasonic acoustic wave or any suitable force. The membrane structure 102 is preferably sufficiently flexible. The membrane structure 102 may alternatively be made with any suitable size.

### Fabrication Method

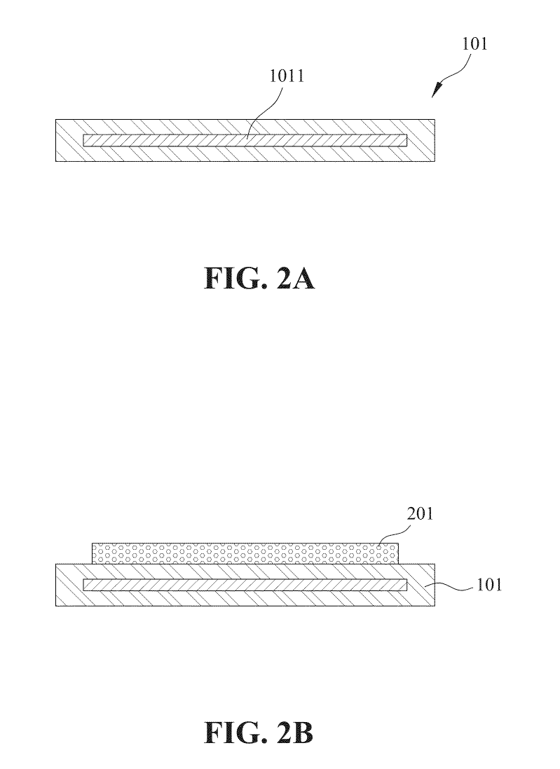

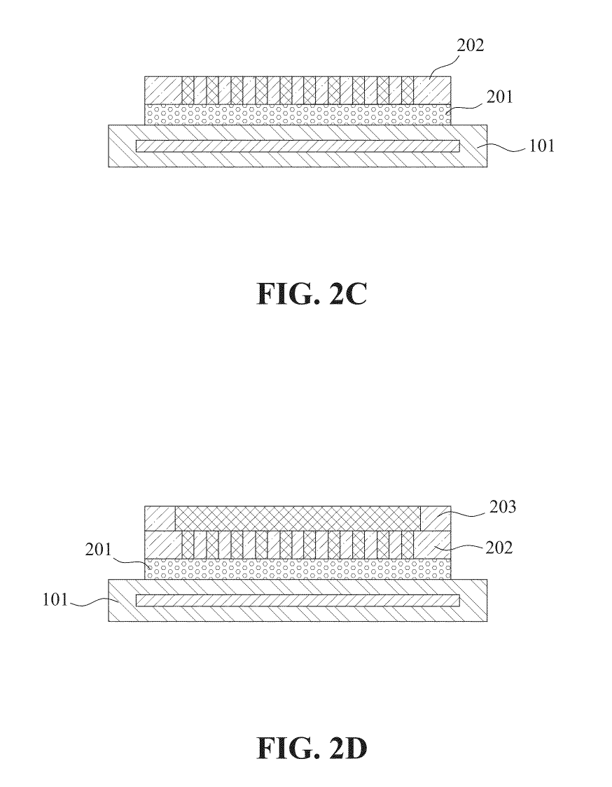

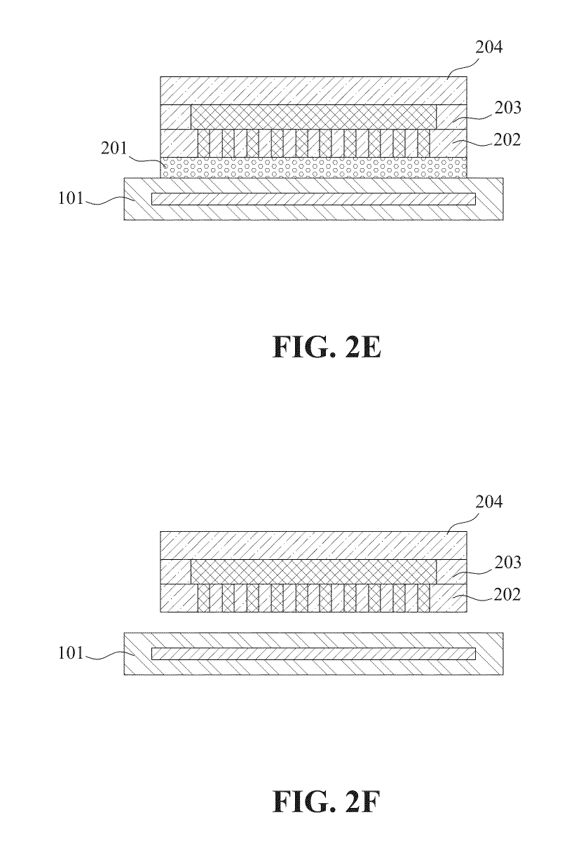

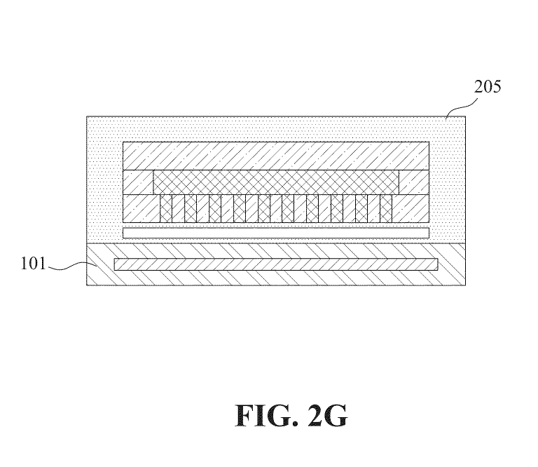

As shown in FIG. 2A-G, a side view of a cross-section of an exemplary fabrication method embodiment of a zero-bias capacitive micromachined ultrasonic transducer (CMUT) element 10 is illustrated. The method for fabricating a zero-bias capacitive micromachined ultrasonic transducer element comprising the steps of: providing a substrate 101 having a lower electrode 1011 formed therein, as shown in FIG. 2A; forming a sacrificial layer 201, a contact layer 202, an upper electrode layer 203 and an insulation layer 204 in sequence, as shown in FIG. 2B-E, wherein the sacrificial layer 201 has a height of 0.1˜0.2 μm; removing the sacrificial layer 201 thereby defining a cavity 103 between the contact layer 202 and the substrate 101, as shown in FIG. 2F; and coating a sealant layer 205 with a polymeric material thereby sealing the cavity 103, as shown in FIG. 2G.

The substrate 101 may include one of a glass, silicon or combination thereof. Further, the substrate 101 may include a p-type or an n-type silicon wafer. The lower electrode 1011 may be implanted in the substrate 101. Further, the lower electrode 1011 may include metal, doped polysilicon, a p-type or an n-type material. Alternatively, the lower electrode 1011 may me diffused in the substrate 101.

The sacrificial layer 201 may be any suitable material, such as metal, silicon oxide, or polysilicon, preferably has a thickness of 0.1˜0.2 μm. Sacrificial layer materials that are selected such that an etchant used to etch the sacrificial layer and will not etch the electrode.

The contact layer 202 is composed of a metal and an insulation material, the metal constitute the protruding part of the upper electrode 1021. The metal may be any electrically conductive material, such as copper, aluminum, tungsten or alloys thereof. The insulation material may be silicon oxide.

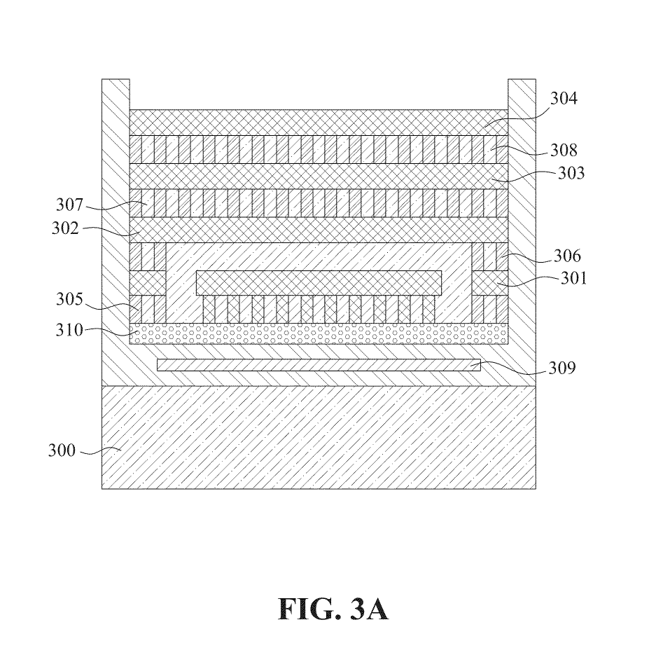

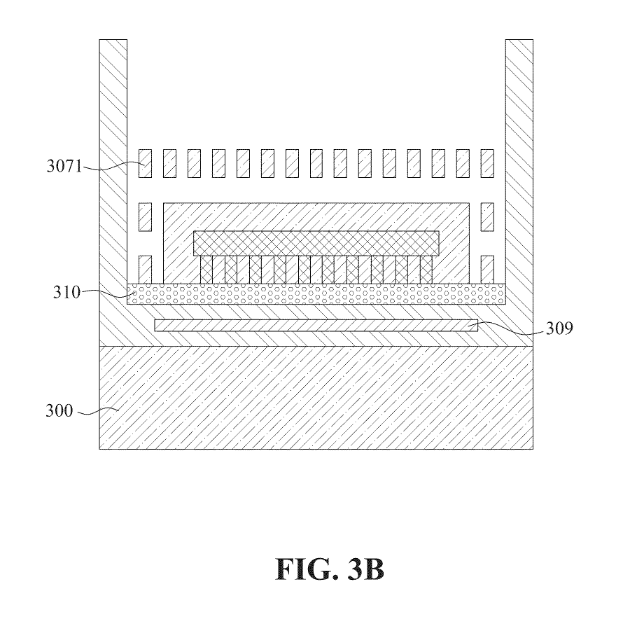

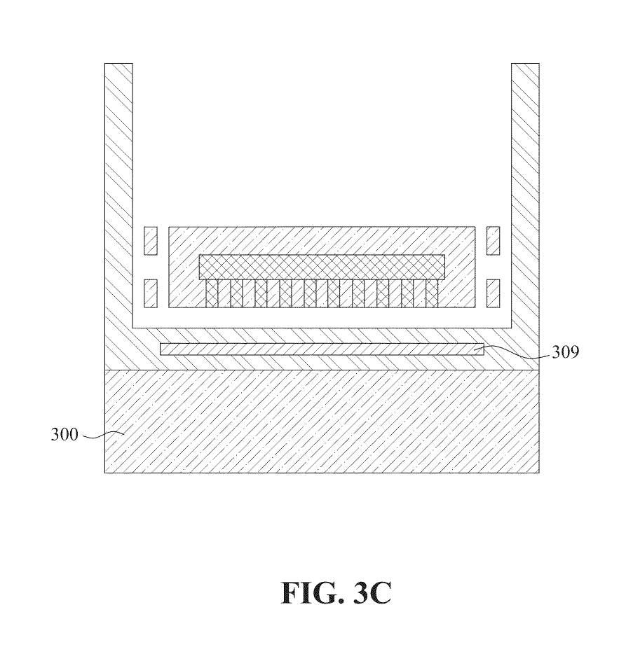

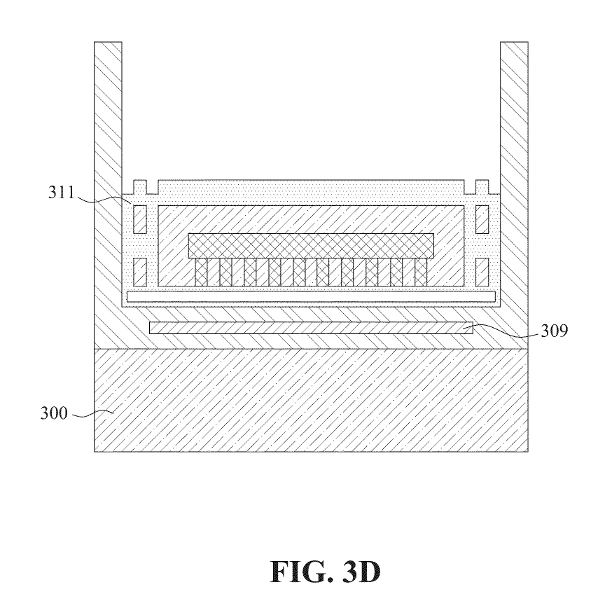

In another embodiment, the fabrication method is fully compatible with CMOS processes as shown in FIG. 3A-F and described below. In this design, we choose the thinnest layer-polysilicon as the sacrificial layer 201 to form the cavity 103 of the device and retain the whole SiO₂ membrane as the insulating membrane to prevent the dielectric breakdown.

The fabrication is base on TSMC 0.35 μm 2P4M CMOS-MEMS process. FIG. 3A is the diagram of a cross section view of the chip returned from foundry, including a silicon wafer 300 and a polysilicon layer 309 surrounded with silicon oxide which served as the substrate 101. First, a mixture of H₂SO₄ and H₂O₂ was used as the etchant to release metal layers 301, 302, 303, 304 (Aluminum) and via layers 305, 306, 307, 308 (Tungsten and TiN), as shown in FIGS. 3A-B. The crisscross shape via layer is designed to enlarge the contact surface between the etchant and the material to be etched. After the crisscross via structures being released, the redundant silicon oxide structures were divided by several little independent pillars on the metal layers 301, 302, 303 thereunder. Those silicon oxide structures (element 3071 for example) would be washed out during the metal etching process, as shown in FIG. 3C. The polysilicon layer 310 served as the sacrificial layer 201 to form the cavity 103 of the device and was etched by tetra methyl ammonium hydroxide (TMAH), also shown in FIG. 3C. Finally, the etching holes were sealed with Parylene-C 311 in vacuum and a thin water proof layer for the device can be optionally formed (FIG. 3D).

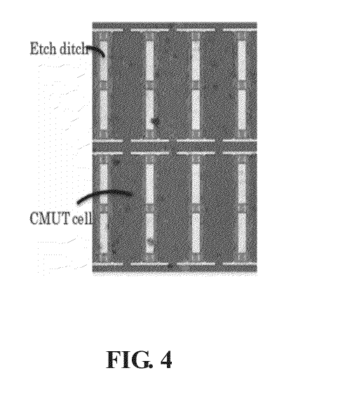

In this post process procedure, etching ditches (FIG. 4) and crisscross vias are designed to minimize the etching time in the post processing. The TMAH etch rate of SiO₂ is 0.1 nm/min. In order to increase the yield rate and reduce the variation of the post processing, it is important to shorten the process time to retain the complete insulating layer and also the device membrane.

The each structure/layer in CMUT element 10 is preferably select from the suitable layer of the chip returned from foundry as described above, but may alternatively be made from any suitable CMOS compatible layer or combination of layers.

The characterizations of the zero-bias CMUTs are performed and discussed below. The performances of zero-bias CMUTs are compared with those operated with a DC bias.

### Measurement of CMUT Transmission

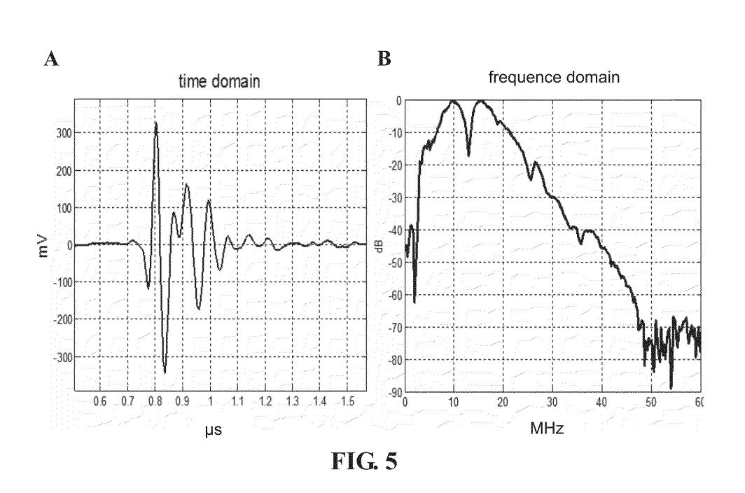

Instead of adding a small AC signal to a DC biased capacitive micromachined ultrasonic transducer to transmit the ultrasonic signal conventionally, only a pulser was utilized to actuate the capacitive micromachined ultrasonic transducer. In this experiment, the CMUT is driven by a commercial pulser (PR5900, USA), using a hydrophone (MHA9-150, Force technology, Denmark) to receive the transmit signal from CMUTs. The signal with 16 times averaging is record by an oscilloscope (Tektronix DP07354). The transmit pressure of CMUT is 760 kPa. The center frequency of the transmit signal is 8.25 MHz, and the wide bandwidth of 147% is observed as shown in FIG. 5.

### Pulse-Echo Measurement of CMUTs

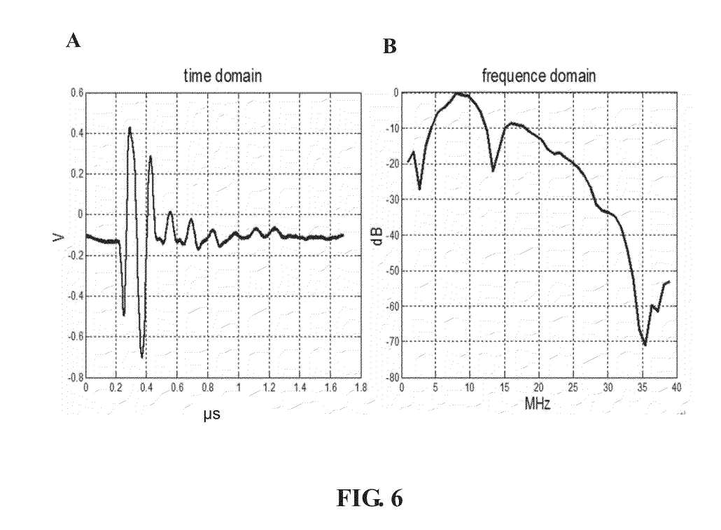

In this experiment, the CMUT is driven by a pulser (PR5077, USA). The transmit signal generated by CMUTs reflects back from the iron plate and the reflected signal is received by the same element. The pulse-echo signal with 16 times averaging is amplified by a receiving amplifier (PR5900, USA) and the signal is recorded by an oscilloscope (Tektronix DP07354). The center frequency of this pulse-echo signal is 7.68 MHz, the fractional bandwidth of this signal is 78.12%, and the receiving sensitivity is 2.894 mV/kPa (FIG. 6).

### Measurement of CMUT Receiving

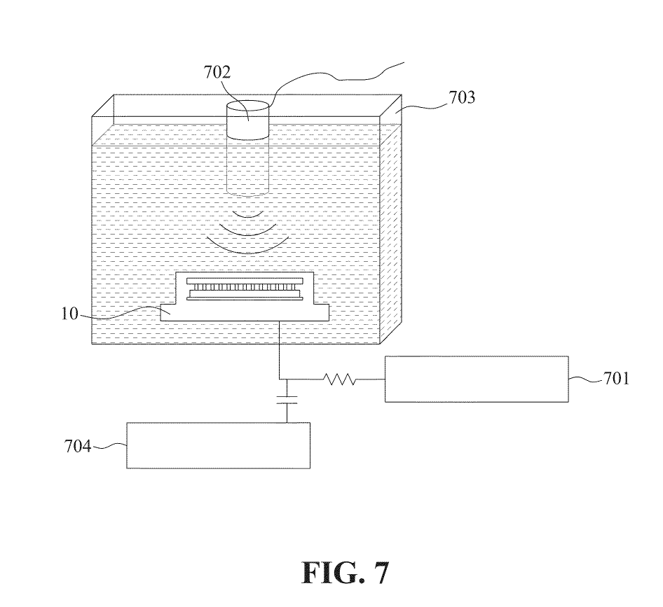

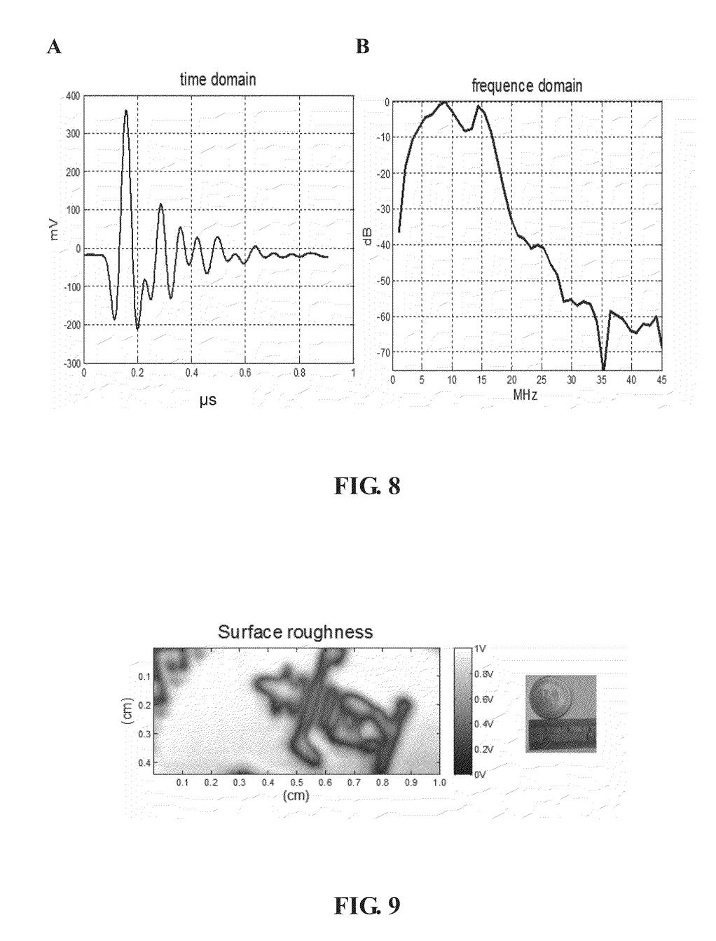

In order to compare the performances of biased and zero-biased CMUTs, the CMUTs 10 were intended to use as a receiver. FIG. 7 shows the experimental setup of this measurement. Our CMUT is biased by a high voltage power supply 701 (Agilent N6700, USA) as a high sensitivity receiver to receive the ultrasonic signal from a commercial 10 MHz PZT transducer 702 (Panametrics V310, Japan) in a water tank 703. After receiving signals from this commercial transducer 702, the receiving signal with 16 times averaging is amplify by a receiving amplifier 704 (PR5900, USA) and the signals are recorded by an oscilloscope (Tektronix DP07354). The receiving sensitivity increases exponentially with the increment of the increasing DC bias. FIG. 8 shows the results when CMUTs are operated at 85% of the collapse voltage. The center frequency of the receiving signal is 8.2 MHz, the fractional bandwidth of the receiving signal is 85%, and the receiving sensitivity of CMUTs is 2.24 mV/kPa.

Compared with the conventional operation, zero-bias CMUT provided approximately the same receiving sensitivity as those CMUTs operated at 85% of the collapse voltage. Furthermore, the pulse-echo signal shows no shift after operating for 5 hours. The results support the hypothesis of the dynamic balance of the dielectric charging during the zero-bias operation of our CMUTs.

As FIG. 6 and FIG. 8 shown, the receive sensitivity of single transducer element with zero-bias operation is equally large to the same CMUT biased at approximately 85% of collapsed voltage as a receiver. Therefore, we briefly assume that during commercial pulser excitation, there was enough extra charge stored in the CMUT.

### CMUT Demonstration by Non Destructive Scanning

One of the applications for ultrasonic transducers is the nondestructive scanning. FIG. 9 shows a C-scan image of a coin obtained by the developed CMUT. In this experiment, we use PR5900 as the pulser to excite our CMUT. The pulse-echo signals were amplified by the receiving amplifier (PR5900, USA) and were recorded by an oscilloscope (Tektronix DP07354).

By using a computer controlled motor (NR-8, Nanomotion, Israel), a mechanical 2D scanning of the coin was demonstrated successfully. Each pulse-echo signal with 16 times averaging is obtained and the 2D image is reconstructed by the custom made software.

The amplitude of the pulse-echo signal shows the information of the surface roughness (FIG. 9) of the coin. The results show very good fit from the real surface information of the coin. By utilizing CMUTs to implement the immersion nondestructive detection, we can successfully reconstruct any object surface by combining both depth and surface roughness information.

In the embodiments described above, the zero-bias capacitive micromachined ultrasonic transducer element could operate without a DC bias, and the fabrication method of the zero-bias capacitive micromachined ultrasonic transducer element could be fully compatible with CMOS process.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A zero-bias capacitive micromachined ultrasonic transducer element, comprising:
a substrate having a lower electrode formed therein;
a membrane structure that structurally supports an upper electrode over the lower electrode, wherein the upper electrode has at least one protruding part thereunder;
a cavity between the substrate and the membrane structure; and
a polymeric material coated on an inner surface of the cavity;
wherein the zero-bias capacitive micromachined ultrasonic transducer element can operate without an DC voltage.

2. The zero-bias capacitive micromachined ultrasonic transducer element as claimed in claim 1, wherein the cavity has a height of 0.1˜0.2 μm.

3. The zero-bias capacitive micromachined ultrasonic transducer element as claimed in claim 1, wherein the polymeric material is a hydrophobic polymeric material.

4. The zero-bias capacitive micromachined ultrasonic transducer element as claimed in claim 3, wherein the hydrophobic polymeric material is selected from the group consisting of Parylene, PDMS, PMMA, and Teflon.

5. The zero-bias capacitive micromachined ultrasonic transducer element as claimed in claim 1, wherein the polymeric material is Parylene-C.

6. The zero-bias capacitive micromachined ultrasonic transducer element as claimed in claim 1, wherein a lower surface of the electrode has 1.2-fold to 5-fold surface area than an upper surface of the electrode.

7. A method for fabricating a zero-bias capacitive micromachined ultrasonic transducer element, the method comprising the steps of:
providing a substrate having a lower electrode formed therein;
forming a sacrificial layer, a contact layer, an upper electrode and an insulation layer in sequence;
removing the sacrificial layer thereby defining a cavity between the contact layer and the substrate; and
coating a sealant layer with a polymeric material thereby sealing the cavity.

8. The method as claimed in claim 7, wherein the lower electrode is disposed on the substrate.

9. The method as claimed in claim 7, wherein the lower electrode is diffused in the substrate.

10. The method as claimed in claim 7, wherein the sacrificial layer has a height of 0.1˜0.2 μm.

11. The method as claimed in claim 7, wherein the sacrificial layer is made of metal, silicon oxide, or polysilicon.

12. The method as claimed in claim 7, wherein the contact layer has a crisscross shape.

13. The method as claimed in claim 7, wherein the polymeric material flow into the cavity and coated on an inner surface of the cavity while coating the sealant layer.

14. A capacitive micromachined ultrasonic transducer, which comprises the zero-bias capacitive micromachined ultrasonic transducer element as claimed in claim 1.
